(19) United States
(12) Patent Application Publication
(10) Pub. No.: US 2008/0284107 A1
(43) Pub. Date: Nov. 20, 2008

(54) Ceramic Brush Seals

(76) Inventors: Andrew L. Flaherty, Lake Zurich, IL (US); Rainer F. Engelmann, Hoffman Estates, IL (US); Amitava Datta, East Greenwich, RI (US)

Correspondence Address: QUARLES & BRADY LLP, 411 E. WISCONSIN AVENUE, SUITE 2040, MILWAUKEE, WI, 53202-4497, US

(21) Appl. No.: 12/120,473

(22) Filed: May 14, 2008

Related U.S. Application Data
(63) Continuation-in-part of application No. 11/121,872, filed on May 4, 2005.
(60) Provisional application No. 60/567,905, filed on May 4, 2004.

(51) Int. Cl. F16J 15/44

(52) U.S. Cl. 277/355

(57) ABSTRACT

The present invention provides a ceramic brush seal including a plurality of ceramic bristles and a support member supporting the plurality of ceramic bristles. Each of the plurality of ceramic bristles extending from a first end to a second end. The plurality of bristles are bent over the support member such that the first end and the second end form a brushing surface on a side of the support member and a fold on an other side of the support member. The plurality of ceramic bristles is made from a ceramic material selected to operate at temperatures in excess of 1500° F.

### CROSS REFERENCES TO RELATED APPLICATIONS

The present application is a continuation-in-part of U.S. patent application Ser. No. 11/121,872, filed on May 4, 2005, which claims the benefit of U.S. Provisional Application No. 60/567,905, filed on May 4, 2004. The entire contents of the above applications are incorporated herein by reference in entirety.

### TECHNICAL FIELD

This invention relates generally to non-metallic brush seals for sealing a gap between a high pressure and a low pressure area and, more particularly, to a brush seal made from ceramic bristles.

### BACKGROUND

The use of brush seals for sealing gaps, such as those found in gas turbine engines, is known in the art. For example, in gas turbine engines brush seals are often utilized to minimize leakage of fluids at circumferential gaps, such as between a machine housing and a rotor, around a rotary shaft of the engine, and between two spaces having different fluid pressure within the engine. The fluid pressure within the system, which may be either liquid or gas, is greater than the discharge pressure (the pressure outside the area of the engine housing, toward which the fluid will tend to leak), thus creating a pressure differential in the system. As used herein, the system pressure side of the brush seal is referred to as the high pressure side, while the discharge pressure side of the brush seal is referred to as the low pressure side.

Conventional brush seals include a bristle pack which is traditionally flexible and includes a plurality of bristles for sealing the gap, the bristles having a free end for contacting one component, such as the rotor. Circular brush seals have been utilized in gas turbine engine applications to minimize leakage and increase engine fuel efficiency. Conventional brush seals are made from metallic fibers, which are typically cobalt or nickel-base high temperature superalloy wire products suitable for elevated temperature operation. Because brush seals are contacting seals where bristle tips establish sealing contacts against the rotor surface, their applications are generally limited to surface speeds of less than about 1200 ft/sec and temperatures below about 1500° F. (usually below about 1200-1300° F.).

At extremely high surface speeds and temperatures, metallic brush seals have been found to suffer from excessive wear resulting from bristle tip melting. There are many areas in existing gas turbine engines, such as balance piston and other secondary flow areas near the gas path where surface speed and temperature conditions are typically beyond the capabilities of conventional metallic brush seals. As such, these locations are generally sealed by large-gap labyrinth seals which have been found to have high levels of leakage during use as compared to contacting seals such as carbon seals and metallic brush seals. Rotating intershaft seals, for both co-rotating and counter-rotating shafts, for example in advanced military aircraft engines, are also generally labyrinth type seals.

Metallic brush seals are also not traditionally used for sealing buffer air near the bearing cavity. Buffer air is used to seal the bearing lubricant by pressurizing the buffer air higher than that of bearing lubricating oil pressure. Metallic brush seals are not used because metallic debris could reach the interface between the bearing elements (balls, pins . . . ) and races causing bearing damage, rotor damage, and failure. Again, current seals used at these locations are generally high-leakage labyrinth seals. Higher leakage for bearing oil seals is not desirable because of contamination of downstream components and cabin air that can be introduced through the leak path. Appropriate carbon seals have not yet been developed for such applications because of their fragile characteristics and low damage tolerance.

Large diameter main shaft bearing oil seals for large aircraft engines or land based turbo machinery are also typically labyrinth seals with large clearances that lead to oil contamination. In these applications, large diameter carbon seals are expensive and metallic brush seals are not suitable.

Although there have been developments in creating non-metallic brush seals, the use of polymeric or ceramic material to replace the metallic bristles has met with many design challenges due, in part, to the difficulty in handling and fabricating brush seals from such material. Typically ceramic or polymeric fibers are very thin, averaging in the range of about 2-3 μm in diameter. Fibers that are this thin have not traditionally been considered suitable for fabricating bristle strips. For example, the flexibility of the thin fibers can make it difficult to machine the inner diameter (ID) of the brush seal to the required tolerances.

Therefore, there exists a need for a contacting seal that minimizes leakage as compared to traditional labyrinth type seals, which can operate under higher temperatures and/or higher speeds than existing metallic brush seals, and which can be readily fabricated.

### SUMMARY

In accordance with the present invention, there is provided a contacting brush seal including a plurality of bristles fabricated from non-metallic materials, the bristles being twisted or braided together substantially along their length (L). The bristles may be particularly made from ceramic or polymeric materials, and in various embodiments are more particularly fabricated from NOMEX®, a synthetic aromatic polyamide polymer, manufactured by DuPont for high temperature applications or Nextel™ 440, an aluminoborosilicate, manufactured by 3M™. In particular, the fabrication of brush seals from Nextel™ 440 fibers provides a brush seal that can operate at temperatures up to 1800° F. while not melting, becoming brittle, or being excessively abrasive to the engine components.

### BRIEF DESCRIPTION OF THE DRAWINGS

It should be understood that the drawings are provided for the purpose of illustration only and are not intended to define the limits of the invention. The present invention is not limited to the precise arrangements and instrumentalities shown in the drawings, and the drawings are not necessarily to scale, emphasis instead being placed upon illustrating the principles disclosed herein, wherein:

FIG. 1 is a perspective view of a mechanically captured prior art brush seal;

FIG. 2 is schematic illustration of a polymeric brush seal design including a flexible front and back plate;

FIG. 3 is a schematic illustration of the flexible front and back plates of FIG. 2 including radial slots; and

FIG. 4 is a photograph of twisted NOMEX® brand fibers for the brush seal of FIGS. 1 and 2.

### DETAILED DESCRIPTION OF THE PREFERRED EMBODIMENT

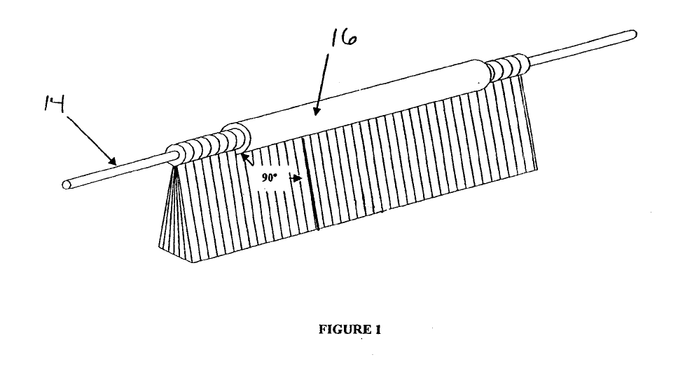

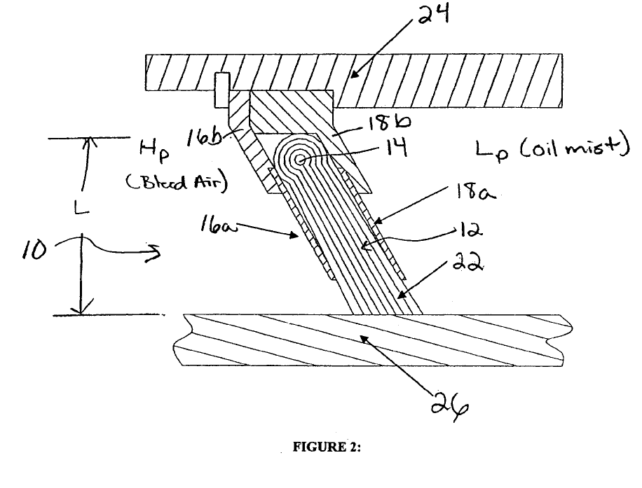

Referring initially to FIG. 2, there is illustrated a non-metallic brush seal 10 including a plurality of ceramic or polymeric bristles 12 supported around a rod or core 14. Because ceramic or polymeric bristles cannot be welded like metallic bristles 13 to fabricate brush seals, the ceramic or polymeric bristles are mechanically captured and secured. The bristles may be folded or wound about the core as shown schematically in FIG. 2. In the present embodiment, a clamping channel 16, such as the conventional channel shown in FIG. 1, or U-ring, may be utilized to further secure the bristles to the core wire 14 by crimping the channel over the wound bristles. For added security, the bristles may be glued or cemented to the rod in the mechanically captured condition, as desired.

These ceramic or polymeric bristles 12 can be twisted or braided into thicker diameter filaments about 0.02 to 0.05 inches in diameters. Brush seals can be fabricated from these braided filaments as described below. Ceramic bristles may be made from suitable high temperature ceramic filaments, including, but not limited to: Aluminum Oxide/Silicon Oxide/Boron Oxide or Nextel™ fiber; Silicon Carbide fiber; other ceramic fibers generally made for ceramic/metal or ceramic/ceramic composites. Polymeric bristles may be made from suitable high temperature ceramic materials, including, but not limited to: KEVLAR® brand filaments for extremely high strength; and NOMEX® filaments for high strength and moderate temperature (˜300° C.) applications. Both KEVLAR® and NOMEX® are synthetic aromatic polyamide polymer manufactured by DuPont. Other suitable polymeric materials may be utilized for the twisted or braided filaments for brush seals, as would be known to those of skill in the art.

In the present embodiment, NOMEX®, has been selected for brush seal fabrication because the NOMEX® fibers are generally made into strong fabrics for applications where thermal and flame resistant properties are essential. NOMEX® is the high temperature version of KEVLAR® which is as strong as or stronger than high strength steel. Other general properties of NOMEX® include: 1.) usable in wide range of temperatures from −196° C. to over 300° C.; 2.) broad compatibility with industrially used oils, resins, adhesives and refrigerants; 3.) chemical resistance to acids, alkalis and solvents; 4.) non-toxic; 5.) self-extinguishing; 6.) does not support combustion; and 7.) does not drip or melt when heated or burned.

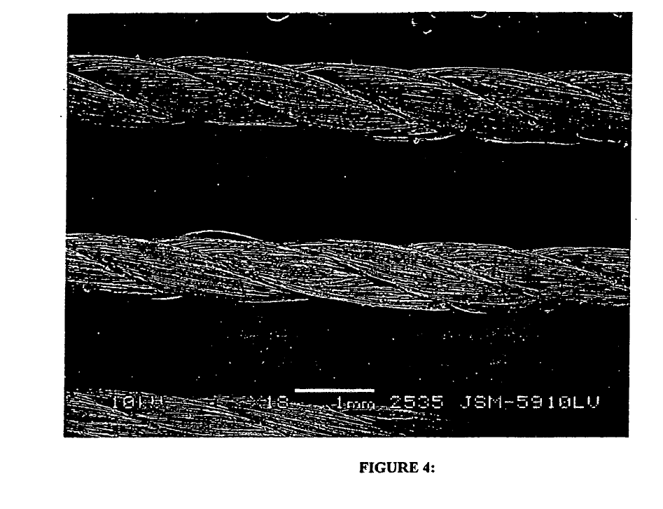

NOMEX® fibers are very thin, in the range of about 25 μm to 0.001 inches in diameter, and have a low modulus of elasticity. In the present embodiment, the fibers are twisted as shown in FIG. 4 to fabricate the brush strips. The twisted NOMEX® fibers are much thicker than the individual fibers, the twisted fibers having a thickness in the range of about 900 μm to 0.036″ in diameter and they are rigid enough to make brush strips using the conventional automatic brush strip manufacturing process. This helps to reduce the fabrication cost of NOMEX® brush strips which will be formed or rolled into brush seal inserts as explained below.

Current automated mechanically captured brush strip manufacturing process is suitable for producing brush strips where bristle are inclined at about 90° to the strip axis and normal to the rotor surface as shown in FIG. 1. Typically, for metallic brush seals bristles are inclined at about 0° to 45° to the strip length in the direction of rotation to provide flexibility and aid in bristle bending during rotor excursion. When bristles are normal to the strip length or rotor surface, they tend to buckle rather than bend, thereby increasing the mechanical contact pressure (P_{mc}) at bristle tips. Increased P_{mc} accelerates bristle wear and shortens the seal life.

In the present embodiment, in order to facilitate bending of polymeric fibers during rotor excursions, the fiber strip is inclined axially in the direction of the fluid flow, i.e., toward the low pressure (Lₚ) side. To provide some rigidity, the flexible fiber pack 12 is held in an axially inclined position between a pair of thinner front 16a and back 18a plates which are attached to more rigid front 16b and back 18b plates as shown in FIG. 2.

The thinner and more flexible front and back plates, located near the ID of the brush seal, protect the filaments from damage during installation, aid in holding the fiber pack together, and minimize its flaring. The flexible plates help to control axial and radial displacements by supporting the fiber pack against pressure and centrifugal forces. The front plate may be fabricated from thin metallic strip which is supposed to contact the bristle pack when the system builds up pressure. Thus, the front plate acts as a flow deflector minimizing bristle blow-down on the rotating surface causing excessive bristle wear. The flexible back plate may also be made from a metallic sheet stock. However, its thickness may be greater than the front plate thickness. The thicker back plate is designed to support the bristle pack under pressure. Both the flexible front and back plates may be held in position by a brush seal housing having a rigid front and back plate as shown in FIG. 2.

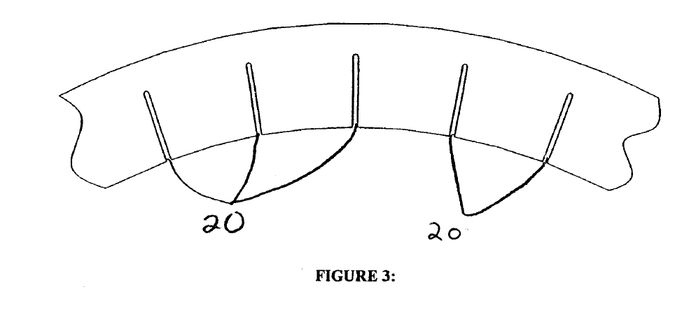

The flexible front and back plates may also be divided into segments by radial slots 20 as shown in FIG. 3, thereby allowing segments to bend. By optimizing the design of the radial segments of the flexible front and back plates, the displacement of the polymeric fiber pack caused by differential pressure and centrifugal forces at various operating conditions can be controlled. For example, the fiber pack is allowed to bend axially as the differential pressure and centrifugal force increase with the rotor speed. By controlling axial bending of the fiber pack, the radial clearance between the seal inner diameter and rotor outer diameter or its interference can be maintained relatively constant throughout the engine operating cycle.

The flexible plates may preferably extend a predetermined length of the bristles so as to expose only the bristle tip area 22, and protect the softer polymeric fibers from being damaged during installation and mishandling. The polymeric brush seal may be attached to the stator housing or to a rotating shaft 24 at a first end for an intershaft seal configuration and contact rotor 26 at a second end. For a rotating seal, the stresses in the polymeric fibers resulting from the centrifugal force are minimized as the fiber pack is supported by flexible metallic back plate segments. The metallic segments are designed to withstand the maximum bending stress due to centrifugal force. By securing the twisted fiber strips between axially inclined coned front and back plates in the direction of the fluid flow, the plates including a rigid annular section at the outer diameter and flexible section at the inner diameter, fiber pack displacement is controlled and stresses in the fiber pack are minimized.

An order of magnitude value of the maximum bending stress induced in a rotating flexible metallic segment is estimated in the following example. The following example is provided for purposes of illustration only and is not intended to limit the scope of the present invention.

Assuming that the flexible back plate is made from age hardened Inco 718 (density=0.295 lbm/in³ and Y.S.=130,000 psi); the size of each finger segment:

width=1.0 inches

length=0.25 inches

thickness=0.05 inches

mass of each finger=1.0 in×0.25 in×0.05 in×0.295 lbm/in³=0.0037 lbm

and at the center of mass of each finger,

surface speed=500 ft/sec

radius=0.5 ft

centrifugal force (F_{cf}) acting radially outward on each finger is given by:

$$\frac{( 0.0037 ) \times {( 500 )}^{2}}{.5} lbf or {F}_{cf} = 1850 lbf .$$

If the cant angle of fingers with respect to a vertical plane is 10°, the bending force (Fₙ) acting normally through the center of mass of each finger

Fₙ=F_{cf} sin 10°=1850 lbf×0.174=322 lbf

[Note: The F_{cf} will vary along the length of the finger and it needs to be integrated for a more accurate estimate]

Therefore, the maximum bending stress (σₘₐₓ) generated at the surface of each finger

$${σ}_{max} = \frac{3 \cdot {F}_{n} \cdot L}{w \cdot {t}^{2}}$$

where,

Fₙ=normal force acting through the center of mass=322 lbf

L=length of finger=0.25 inches

w=width of fingers=1 inches

t=thickness of finger=0.05 inches

$${σ}_{max} = \frac{3 \times 322 \times .25}{1 \times {( .05 )}^{2}} = 96 , 000 psi$$

This is well below the Y.S of Inco 718. The rest of the rigid structure of the rotating seal can easily be optimized to maintain stresses below the yield stress. For design optimization, detailed Finite Element Analysis (FEA) of the entire structure may be performed.

In another form, the inventive brush seal can have bristles formed from a ceramic material such as, for example, Nextel™ 440 ceramic fibers as may be obtained from 3M™. Nextel™ 440 ceramic fibers are composed of 70% Al₂O₃, 28% SiO₂, and 2% B₂O₃ by weight and have γ-Al₂O₃, mullite, and amorphous SiO₂ crystal phases. Braiding or twisting of the fibers may be needed to provide sufficient rigidity for machining the fibers, since the diameter of the as-obtained fibers is approximately 10 to 12 μm. As the melting point of Nextel™ 440 is approximately 3200° F., it has excellent high temperature chemical stability in even the hottest portions of an engine.

Although others have attempted to use aluminoborosilicates and aluminosilicates in fabrication of brush seals before, none have had the success operating at extremely high temperatures as found in the present invention. At high temperatures, it has been found that many other aluminoborosilicates and aluminosilicates compositions either melt or are too brittle for brush seal applications.

For example, in trials it was found that Nextel™ 312 fibers (62.5 wt % Al₂O₃, 24.5 wt % SiO₂, and 13 wt % B₂O₃) would melt during at high temperatures during the application and that Nextel™ 550 fibers (73 wt % Al₂O₃ and 27 wt % SiO₂) were too brittle and failed during the application. Both the Nextel™ 312 and Nextel™ 550 fibers are identified by 3M™ as having the same melting point as the Nextel™ 440 fibers. Yet surprisingly, the brush seal made from the Nextel™ 440 fibers is capable of stable performance in even the most extreme engine applications.

It is believed that the low boron content in the inventive ceramic brush seal compared to the other tested fibers provides a self-lubricating effect that can allow the seal to operate at temperatures of up to 1800° F., pressure differentials of up to 300 psid, and speeds of up to 1500 feet per second. The ceramic brush seal is operable in environments in which there is a seal between an air/oil, oil/oil, and other fluids or gases sides. Tests have shown that the use of the ceramic brush seal result in 60-75% less air flow into the bearing sump than a controlled gap seal/labyrinth seal using a pressure differential of 0-35 psid, a room temperature air barrier at 15,000 rpm, and 200° F. turbine oil. Further, while standard metallic bristles generate oil coke beginning at around 350° F., the generation of oil coke during operation has not been shown to be a concern when using brush seals made from Nextel™ 440 fibers.

It will be understood that various modifications may be made to the embodiments disclosed herein. For example, although the fibers are illustrated as twisted, the term “twisted” as used herein is intended to include braided configurations, or any configuration where the fibers intentionally overlap or are wound about at least a portion of the length of the fibers. Likewise, non-metallic materials other than those described herein may be utilized for the twisted fibers. Therefore, the above description should not be construed as limiting, but merely as exemplifications of preferred embodiments. Those skilled in the art will envision other modifications within the scope, spirit and intent of the invention.

We claim:

1. A ceramic brush seal comprising:
a plurality of ceramic bristles, each of the plurality of ceramic bristles extending from a first end to a second end;
a support member supporting the plurality of ceramic bristles, the plurality of bristles bent over the support member such that the first end and the second end form a brushing surface on a side of the support member and a fold on an other side of the support member; and
wherein the plurality of ceramic bristles is made from a ceramic material selected to operate at temperatures in excess of 1500° F.

2. The ceramic brush seal of claim 1, wherein the ceramic material includes Al₂O₃, SiO₂, and B₂O₃.

3. The ceramic brush seal of claim 2, wherein the ceramic material has a plurality of crystal phases including γ-Al₂O₃, mullite, and amorphous SiO₂.

4. The ceramic brush seal of claim 2, wherein the ceramic material includes approximately 2 percent by weight B₂O₃.

5. The ceramic brush seal of claim 1, wherein the plurality of bristles are constructed from a plurality of fibers having diameters in a range of 10 to 12 μm.

6. The ceramic brush seal of claim 5, wherein at least a portion of the plurality of fibers form a bristle in which the portion of the plurality of fibers are twisted with respect to one another.

7. The ceramic brush seal of claim 5, wherein at least a portion of the plurality of fibers form a bristle in which the portion of the plurality of fibers are braided with respect to one another.

8. A ceramic brush seal system comprising:
a housing;
a rotatable shaft, the housing and the rotatable shaft defining a volume therebetween;
a ceramic brush seal disposed between the housing and the rotatable shaft to divide the space into a higher pressure side and a lower pressure side;
wherein at least one of the higher pressure side and the lower pressure side of the ceramic brush seal system has a temperature in excess of 1500° F.

9. The ceramic brush seal system of claim 8, wherein at least one of the higher pressure side and the lower pressure side of the ceramic brush seal system has a temperatures in excess of 1000° F.

10. The ceramic brush seal system of claim 8, wherein the higher pressure side of the ceramic brush seal system has a temperature in excess of 1500° F.

11. The ceramic brush seal system of claim 8, wherein at least a portion of the ceramic brush seal is composed of a ceramic material including Al₂O₃, SiO₂, and B₂O₃.

12. The ceramic brush seal system of claim 11, wherein the ceramic material has a plurality of crystal phases including γ-Al₂O₃, mullite, and amorphous SiO₂.

13. The ceramic brush seal system of claim 11, wherein the ceramic material includes approximately 2 percent by weight B₂O₃.

14. The ceramic brush seal system of claim 8, wherein the ceramic brush seal system can operate at a pressure differential of up to 300 psid between the higher pressure side and the lower pressure side.

15. The ceramic brush seal system of claim 8, wherein the ceramic brush seal system operates at speeds up to 1500 feet per second.

16. A ceramic brush seal system, comprising: a housing; a rotatable shaft, the housing and the rotatable shaft defining a space therebetween; and a ceramic brush seal disposed between the housing and the rotatable shaft to divide the space into a higher pressure side and a lower pressure side, the ceramic brush seal including (i) multiple ceramic braids, each ceramic braid including a first ceramic fiber and a second ceramic fiber which are wound together to form that braid, and (ii) a support member constructed and arranged to support the first ceramic fiber and the second ceramic fiber of each ceramic braid in a twisted configuration, wherein the ceramic braids form a fiber pack, and wherein the support member includes a metallic front plate and a metallic back plate which are constructed and arranged to elastically return the fiber pack from a displaced position to an original position in a spring back manner following displacement of the fiber pack.

17. The ceramic brush seal system of claim 16, wherein at least one of the higher pressure side and the lower pressure side has a temperature of over 500° F.

18. The ceramic brush seal system of claim 16, wherein at least one of the higher pressure side and the lower pressure side has a temperature of over 1500° F.

19. The ceramic brush seal system of claim 16, wherein at least a portion of the ceramic brush seal is composed essentially of a ceramic material including 70 percent by weight Al₂O₃, 28 percent by weight SiO₂, and 2 percent by weight B₂O₃ and has a plurality of crystal phases including γ-Al₂O₃, mullite, and amorphous SiO₂.

20. The ceramic brush seal system of claim 16, wherein the ceramic fibers include approximately 2 percent by weight B₂O₃.
